(19) United States
(12) Patent Application Publication
(10) Pub. No.: US 2015/0279245 A1
(43) Pub. Date: Oct. 1, 2015

(54) PART OF A PACKAGE

(71) Applicant: UPM RAFLATAC OY, Tampere (FI)

(72) Inventors: Eija Siekkinen, Tampere (FI); Päivi Kangas, Tampere (FI); Ismo Pietari, Tampere (FI)

(21) Appl. No.: 14/431,929

(22) PCT Filed: Oct. 4, 2013
(86) PCT No.: PCT/FI2013/050963

§ 371 Date: Mar. 27, 2015

Related U.S. Application Data
(60) Provisional application No. 61/710,274, filed on Oct. 5, 2012.

(30) Foreign Application Priority Data
Oct. 5, 2012 (FI) 20126043

(51) Int. Cl. G09F 3/10; B05D 5/00; B05D 3/12

(52) U.S. Cl. CPC G09F 3/10; B05D 3/12; B05D 5/00; G09F 2003/0208

(57) ABSTRACT

The invention relates to a label and to a facestock of a label comprising a plastic facestock, at least one inorganic coating layer, and a printing layer. The inorganic coating layer is configured to provide a barrier layer for migration of at least one substance from the printing layer. The invention also relates to a use of a label, to a method for producing a label, and to a combination of an item and a label.

### FIELD OF THE INVENTION

The present invention relates to packages, and more specifically to a part of a package including graphical patterns. The invention also relates to a manufacturing and a use of a part of a package.

### BACKGROUND OF THE INVENTION

Packages are products enclosing or protecting items for distribution, storage, sale and use. Packages may be made of different materials, such as plastic, glass or paper. For example, plastic films may be used for packaging of food in order to keep them fresh over a longer time period. Generally packages include a part comprising graphical patterns in order to provide a visual effect and/or in order to display information about the product. Graphical patterns may be, for example, directly printed on the surface of the package or they may be on a separate but associated label, such as an adhesive label adhered to the surface of the package. It is general practice to apply a label onto a surface of an item to provide decoration, and/or to display information about the product being sold, such as the content of the item, a trade name or logo. A label typically comprises a facestock layer and an adhesive layer for attaching the facestock to an item. The label facestock may be either a paper or plastic film or a combination of these. Plastic packages and labels are increasingly preferred.

### SUMMARY OF THE INVENTION

It is an object to provide a part of a package suitable for including graphical patterns in order to provide a visual effect and/or in order to display information about the item. Another object is to disclose a method for manufacturing a part of a package.

According to a first aspect, a label is provided. The label may comprise a plastic facestock having a first surface and a second surface, at least one inorganic coating layer, and a printing layer. The inorganic coating layer may provide a barrier layer for migration of at least one substance from the printing layer.

According to a second aspect, there is provided a method for producing a label including a facestock, at least one inorganic coating layer, and a printing layer. The method may comprise steps of providing a plastic facestock, coating at least one surface of the facestock with an inorganic material, printing the facestock so as to form a printed facestock, and cutting the printed facestock so as to form a printed label.

According to a third aspect, a facestock for labels is provided. The facestock may comprise at least one inorganic coating layer, and a printing layer. The inorganic layer is configured to provide a barrier layer for migration of at least one substance from the printing layer.

According to a fourth aspect, a use of a label for labelling of an item is provided. The labelling may comprise attaching the label onto the surface of an item through an adhesive layer. Alternatively, the label may be attached by heating providing shrinking of the label. Label may also be attached during manufacturing of an item, i.e. in-mold.

According to a fifth aspect, a combination of an item and a label attached to the item is provided. The inorganic coating layer may provide a barrier layer for migration of at least one substance from the printing layer. Preferably, the barrier hinder the migration of at least one substance through the barrier layer into the item.

Further embodiments are presented in the dependent claims.

A thickness of the inorganic coating layer may be smaller than 500 nm, preferably smaller than 150 nm or smaller than 100 nm.

The inorganic coating layer may comprise at least one of the following: TiO₂, Al₂O₃, SiO₂, Si₃N₄, AlSiOₓ, and ZnO.

The opacity of the facestock may be lower than 10%, preferably lower than 5%, or lower than 4% according to the standard ISO 2471.

The printing layer may comprise at least one migrating substance from the group consisting of printing inks, primers, lacquers and overprint varnishes.

The printing layer may comprise migrating substance consisting of UV-curable printing ink comprising at least one of the following photoinitiator: benzophenol, acetophenol, tertiary amin, acrylic amin, and 2-isopropylthioxanthone.

The migration of the at least one substance of the printing layer may be less than 60 ppm, preferably equal or less than 10 ppm.

In addition, the label may comprise an adhesive layer against the second surface of the facestock layer and the inorganic coating layer between the facestock layer and the adhesive layer. The adhesive layer may consist of a pressure sensitive adhesive.

In addition, the method may further comprise coating the facestock with an adhesive layer. Coating of the facestock with inorganic material may be continuous atomic layer deposition process performed prior to coating the facestock with adhesive layer.

### DESCRIPTION OF THE DRAWINGS

In the following, the invention will be explained with reference to the drawings, where

FIG. 1 presents an example embodiment of a package,

FIG. 2 presents, in a cross sectional view, a label structure,

FIG. 3 presents, in a cross sectional view, an example embodiment of a part of a package,

FIG. 4 presents, in a cross sectional view, an example embodiment of a part of a package,

FIG. 5 presents, in a cross sectional view, an example embodiment of a part of a package,

FIG. 6 presents, in a cross sectional view, a multilayered inorganic coating,

FIG. 7 presents a schematic figure of a laminating process,

FIG. 8 presents an example embodiment of a continuous ALD process,

FIG. 9 presents an example embodiment of a continuous ALD process,

FIG. 10 presents an example embodiment of a continuous roll-to-roll ALD process,

FIG. 11 presents, in a cross sectional view, a label attached onto a surface of an item.

### DETAILED DESCRIPTION OF THE INVENTION

A term “package” refers to a product enclosing or protecting items. The package may be, for example, a bottle, a box, a bag, or a wrapping film, made of glass, plastic, paper, cardboard or any combination thereof. For example, the package is made of a plastic film. Plastics in packaging include polymers, such as polyesters e.g. polyethylene terephthalate (PET), poly(vinyl chloride) (PVC), polypropylene (PP) and polyethylene (PE).

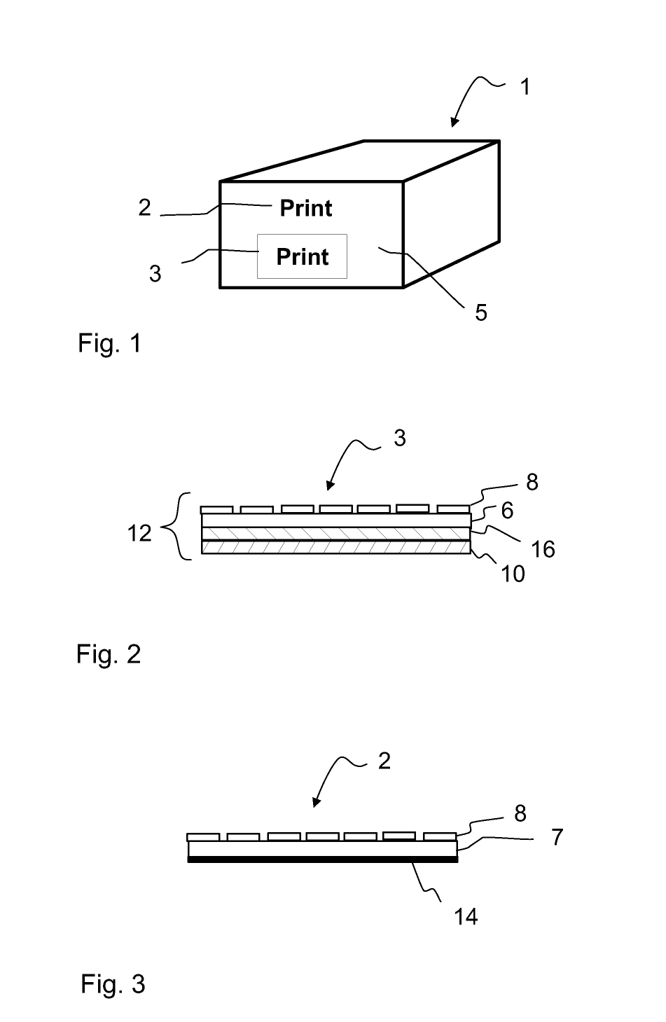

An example of a package 1 is shown in FIG. 1. A part of the package refers to a part comprising graphical patterns displaying e.g. information about the product. The part of a package may be an integral part 2 of the package i.e. the graphical patterns may be directly printed on the surface 5 of the package, such as a plastic film. Alternatively, the part of a package may consist of a separate associated label 3, such as an adhesive label adhered to the surface 5 of the package.

The graphical patterns may be manufactured by conventional printing methods, such as gravure or flexographic processes. In order to provide high printing speeds, thin and controllable ink thickness or good colour coverage, flexographic printing is preferred. Flexographic inks may be solvent-based, water-based, or radiation curable. For example, UV curable inks may be used for flexographic printing as well as in ink-jet printers. The flexographic printing may be used in the packaging industry for the printing of flexible packages, such as plastic wrappings, corrugated board as well as adhesive label laminates.

Flexographic printing is a mechanical letterpress method which is characterized by a soft and flexible printing plate. At the printing stage, the material to be printed is conveyed between the flexible printing plate and a hard backing roll, wherein printing ink is transferred by pressing to a desired location in the material to be printed. In multicolour printing, the ink layer needs to be dried (cured) after every printing unit. For example, UV curable inks may be used. UV curable printing inks are printing inks whose curing is not based on the evaporation of a solvent substance as in conventional printing inks but on a polymerization reaction by means of UV radiation and oxygen. According to their name, UV printing inks are cured by ultraviolet radiation whose wavelength is typically 180 to 380 nm. Advantages of using UV curable printing inks include the lack of a solvent, which makes it possible to reduce effluents compared with solvent-based printing inks. Also, the curing rate, formability, good resistance to chemicals and scratching, and colour saturation are examples of the advantages of the ink. With UV printing inks, the thickness of the printing ink layer is typically 0.8 to 2.5 μm, while it is about 0.8 to 1 μm for solvent-based inks. Because no mass is evaporated from UV inks after printing, it is easier to adjust the layer thickness. Because no evaporation takes place, the inks are not spread, wherein the print quality is better. Compared with conventional printing inks, radiation curable printing inks also have the advantage of a very high curing rate. The printing surfaces of UV inks are strong and glossy, which makes them a very good alternative for the printing of products susceptible to wear, such as labels.

The main components of the printing inks in mechanical printing are pigment, binder and solvent. In UV printing inks, the binder used consists of oligomers, which are often epoxy, polyester, urethane or acrylate based. Even if there are no actual solvents, functional monomers can be regarded as such in UV printing inks. The most important additive is the photoinitiator which enables the polymerization reaction. UV ink may comprise, for example, between 50 and 70% of a binder, between 10 and 30% of functional monomers, between 20 and 25% of pigment, and between 5 and 10% of additives, such as photoinitiators. Photoinitiators are compounds which contain reactive groups and react to high-energy radiation by starting the polymerization reaction. The energy of UV radiation as such is not sufficient for starting the polymerization reaction, so that the photoinitiators are a very important component in UV printing inks. The most typical photoinitiators which form free radicals contain benzophenols, acetophenols, tertiary or acrylic amines, or their derivatives. For example, 2-isopropylthioxanthone (ITX) may be used as a photoinitiator. By the energy of UV radiation, the photoinitiators of the printing ink react by producing free radicals. As a result of the reaction, the monomers and oligomers in the printing ink are combined and cross-linked to each other, forming polymer chains and simultaneously curing the printing ink to a solid film. This reaction is very fast, because it takes no longer than a few seconds, normally in some hundredth parts of seconds. The photoinitiator may start the curing reaction either by breaking into free radicals, or ions.

A label refers to a piece of material attached to an article. The label is used to provide a visual effect and/or to designate, for example, its origin, content or use. Referring to FIG. 2 a label 3 comprises at least a face material layer 6, which refers to the top layer of the label, also called a facestock or face layer, and a printing layer 8. The label consisting of the facestock layer and the printing layer may be referred to as a printed label. The printing layer may be on the top or the reverse side of the facesock 6. In order to avoid additional protective layer(s) (overlaminate layer) on top of the printing layer, printing the reverse side of the facestock may be preferred. The face material layer may be a plastic film. Alternatively, it may be a paper based. The printed label may be non-adhesive, such as a shrink sleeve or in-mold label, or it may comprise an adhesive layer 16 so as to form a printed adhesive label. Thanks to the adhesive layer 16, the label can be affixed to the surface of a product. The adhesive layer may consist of a heat activated adhesive, a wet glue adhesive or a pressure sensitive adhesive (PSA). The labels consisting of PSA can be adhered to most surfaces through an adhesive layer without the use of a secondary agent such as a solvent or heat to strengthen the bond. The PSA forms a bond when pressure is applied onto the label at room temperature, adhering the label to the product to be labelled. The label comprising a pressure sensitive adhesive may be referred to as a pressure sensitive adhesive (PSA) label. Alternatively, the label may be attached to the article by heating which causes shrinking of the label and the attachment of the label. Label may also be attached during manufacturing of an item, i.e. in-mold.

The label structure may also comprise a release liner 10 comprising a backing material coated with a layer of a release agent, such as silicone, so as to form a printed label laminate 12. The backing material may be plastic film or paper based. The plastic film may be, for example, a polyester film, a biaxially or machine-direction oriented polypropylene film. The thickness of the plastic liner is preferably 20 to 30 microns or even less than 20 microns. Paper liners may have a thickness between 40 and 60 microns. The individual labels 3 may be cut from the label laminate structure. After the cutting, a number of individual labels may be attached to a release liner 10 which remains continuous and uncut. Alternatively, the individual labels may be completely separate, i.e. the liner may be cut as well. The release liner protects the adhesive and is removed prior to the application of the label onto a surface of an item. Also linerless labels or non-adhesive labels, such as shrink sleeves or in-mold labels, may be provided in a continuous label web, which may be further cut to form individual labels. The label may be used for labelling of items, such as plastic or paper packages, bottles, or other containers.

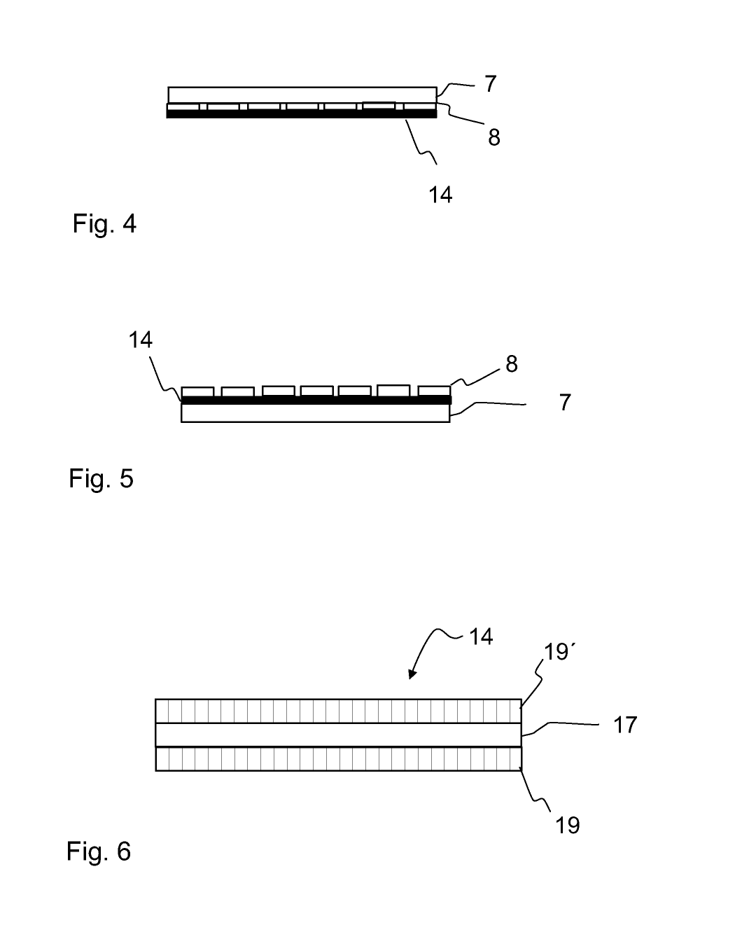

With reference to FIG. 3, according to an embodiment at least a part of the package 2 consists of a plastic film 7 having a first surface and a second surface, graphical patters 8 on first surface of the plastic film, and an inorganic coating layer 14 on the second surface of the plastic film. Alternatively, with reference to FIG. 4, the graphical patterns 8 may be printed on the second surface of the plastic film 7 and subsequently coated with an inorganic layer 14. Referring to the FIG. 5, the inorganic coating layer 14 may be manufactured on the first surface of the plastic film 7, which inorganic layer further comprises a printing layer 8. In addition, an inorganic layer may also be on top of the printed layer 8. For example, an additional layer comprising an inorganic coating may be over laminated or inorganic layer may be directly coted on top of the printed layer. It is also possible that the whole package, such as a plastic film, wrap or sleeve, contains a continuous inorganic coating layer. The plastic film may be treated prior to inorganic coating process, for example by using flame, corona or plasma treatment in order to provide better anchorage of the coating layer.

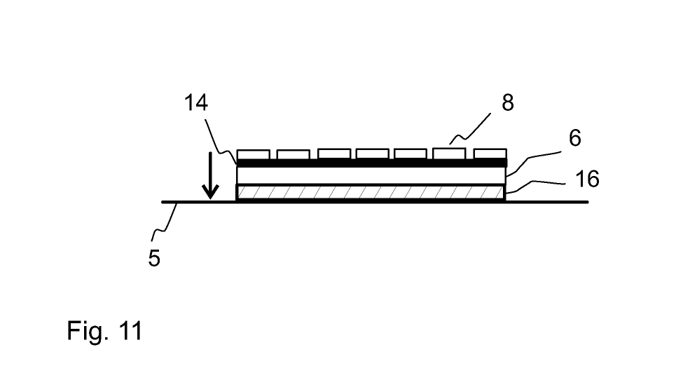

Referring to FIG. 11, the inorganic coating layer 14 is configured to provide a barrier layer, for example, against migration of printing ink substance(s) from the printing layer 8. The migration may be eliminated in the direction shown with the arrow. Preferably, the barrier hinder at least the migration of at least one substance through the barrier layer into the item. In other words, the inorganic coating layer may prevent the migration of substance(s) of printing ink having migration potential, i.e. the coating layer may prevent transfer of substance(s) susceptible for migration. Thanks to the barrier layer the migration of substance(s) harmful for the package or for the product inside the package may be avoided.

The inorganic coating layer may be manufactured by using Atomic Layer Deposition (ALD) technology. ALD technology can be used for both plastic materials and papers; for example plasma assisted atomic layer deposition (PA-ALD) is suitable for low temperature applications, such as for plastic films. ALD coating layer provides high quality barrier layer suitable for preventing the migration of foreign matters, such as substances from printing inks. The inorganic coating layer may be composed of inorganic materials, such as metal or silicon oxides or silicon nitrides. The inorganic coating layer may include one or any combination of following compounds: TiO₂, Al₂O₃, SiO₂, Si₃N₄, AlSiOₓ and ZnO.

According to one embodiment, the inorganic coating layer may include only one type of compound, for example, TiO₂ or Al₂O₃. Alternatively, it may have a layered laminate structure (lamellar composite structure) consisting of two, three, five or more compounds listed above. For example, the inorganic coating may have a hybrid structure including one layer of TiO₂ and another layer of Al₂O₃. With reference to FIG. 6, the inorganic coating layer 14 may have a composite structure consisting of three layers. The three layer structure may include a core layer 17 having a different composition than skin layers 19, 19′. Alternatively, all three layers (core and skin layer) may have different composition. Also the thickness of the individual layers may vary. Thanks to the multilayer structure e.g. the barrier properties of the inorganic coating layer may be optimized.

The plastic film of a label or a package may have a monolayer structure, also called a single layer film. Alternatively, it may have a multilayer structure consisting of two or more plastic film layers. A wide variety of polymers are useful in preparing the plastic film. The plastic film may include at least one homopolymer, copolymer, or it may be a polymer blend. The plastic film may comprise polyolefin(s), such as polypropylene (PP) and polyethylene (PE), polyester(s) e.g. polyethylene terephthalate (PET), poly(vinyl chloride) (PVC), or any mixtures thereof. The polyethylene may be low density polyethylene (LDPE), linear low density polyethylene (LLDPE), high density polyethylene (HDPE), or a blend thereof. The film may comprise, for example, both low density polyethylene (LDPE) and high density polyethylene (HDPE). Alternatively, the plastic film may be biodegradable and comprise at least one of the following polymers: polylactide (PLA), poly(hydroxyalkanoates), modified poly(saccharides) e.g. cellulose, starch, lignin and chitin. The multilayer plastic film may comprise individual layers having different compositions, or alternatively all layers may have the same composition. For example, the individual layers of the multilayer plastic film may all have same composition, e.g. polyethylene. Optionally, the layers may have different compositions, e.g. one layer of polyethylene and another of polypropylene. It is also possible, that at least one layer includes a polymer blend, e.g. a blend of polyethylene and polypropylene. In a multilayer film, separate layers may also have different thicknesses. Multilayer plastic film packages may also comprise moisture and/or oxygen barrier(s), such as additional layer of polyamide (PA) or ethylene vinyl alcohol (EVOH).

In addition, the plastic film may comprise additives, such as pigments or inorganic fillers to provide, for example, a desired colour for the film. The additives may include, for example, titanium dioxide, calcium carbonate and blends thereof. The film may also comprise minor contents of other additives and/or film modifiers, e.g., an antiblocking agent, a UV stabilizer.

The monolayer plastic film may be, for example, a blown or cast film, and/or the film may be extruded. The multilayer film may be, for example, coextruded, or at least two monolayer films may be laminated together. The plastic film may be oriented monoaxially in machine direction (MD) or biaxially in both machine direction (MD) and transverse direction (TD). Thanks to the biaxial orientation, for example, the oxygen and/or water barrier properties of the film may be improved. Further, modulus/stiffness of the film may be may be increased thus enhancing the control of the film during the printing process. Machine direction orientated films may be preferred due to the higher tear resistance of the film. Alternatively, the film may be non-oriented. As an example, the film may be oriented 5 to 8 times in machine direction. Biaxially oriented film may be oriented 5 to 7 times in MD and 8 to 10 times in TD.

A plastic film may have a thickness between 10 and 150 microns, between 15 and 120 microns, between 15 and 75 microns, or between 70 and 150 microns. For example, the plastic film may be a non-oriented polyethylene film having a thickness of between 80 and 150 microns, preferably between 80 and 110 microns or between 80 and 90 microns. A biaxially oriented polypropylene film (BOPP) may have a thickness of 20 to 110 microns, preferably 30 to 90 microns, for example, 50 microns or 60 microns. The plastic film of a label may have a total thickness smaller than 100 microns or smaller than 80 microns, preferably smaller than 60 microns. The plastic film of the label may have a thickness between 30 and 80 microns, or between 40 and 60 microns.

The plastic film comprising the inorganic layer is preferably transparent to visible light in order to provide a clear appearance of the film, which further allows the objects beneath such film to be visible through the film. A clear film is substantially transparent to visible light. The haze of the film may be less than 60%, preferably less than 50% or less than 30%, and most preferably equal to or less than 25%, when measured according to the standard ASTM D1003. In addition, the haze may be at least 1% or 10%. The haze of a clear film may be, for example, between 1 and 30%, or between 2 and 25%.

Alternatively, the plastic film may be white or opaque. White films may comprise fillers, such as TiO₂. The filler may be, for example, in the core layer of the multilayer film. Alternatively, the filler may also be in other layers. Optionally, the film may be cavitated. The cavitated film may comprise, for example CaCO₃. According to an embodiment, the opacity of the plastic film is less than 10% preferably less than 5%, and most preferably less than 4%. For example, the opacity is between 2 and 10%, preferably between 2 and 5%. According to an embodiment, the opacity of e.g. a white film may be at least 70%, at least 75%, or at least 80%, for example between 70 and 95%, or between 70 and 80%. Opacity of the film refers to the degree to which light is not allowed to travel through the film. The opacity is measured according to the standard ISO 2471. Gloss is used as a measure of the shiny appearance of film, i.e. it is the reflection of light from the surface. The gloss of the film may be between 10 and 100%, or between 10 and 85% (according to the standard DIN 67530/1 with gloss angle 60 degrees).

The plastic film may have a secant modulus 1% value in MD between 300 and 450 MPa or between 1000 and 2500 MPa (according to the standard ISO 527-3). For example, biaxially oriented polypropylene films may provide higher modulus values. A bending resistance of a biaxially oriented polypropylene film may be between 30 and 200 mN. Non-oriented polyethylene films may have a bending resistance between 35 and 65 mN. Bending resistance is measured according to the standard ISO 2493.

According to another embodiment, a part of the package consists of a separate label 3 attached to the surface of the package. With reference to FIG. 2, the label 3 comprises at least a facestock layer 6 including graphical patterns 8 (printed layer). The facestock layer may have any of the plastic film structures presented above. The label may further comprise other layers, such as an adhesive layer 16 and a release liner 10. The total label structure may also comprise other additional layers, for example tie layers, in order to improve label properties. An over-vanish or laquer layer may be used to protect the printing layer.

The inorganic layer 14 of the plastic film 6 of the label, also called a facestock layer, may be at least one side of the plastic film. Referring to FIG. 2, in the case of the labels the inorganic coating 14 layer is preferably at the surface of the facestock layer adjacent to adhesive layer i.e. between the facestock layer 6 and the adhesive layer 16. In other words and referring to the FIG. 3, the inorganic coating layer 14 may be manufactured on the second surface of the plastic film 7 and subsequently coated with an adhesive layer so that the adhesive layer contacts a surface of the inorganic layer. Thanks to this specific placement rubbing of the inorganic coating layer 14 may be avoided. Alternatively and with reference to FIG. 5, the inorganic coating layer 14 may be adjacent to the printing layer 8. Referring to FIG. 3, in addition the printing layer 8 may be further over coated with another inorganic coating layer in order to provide protective or barrier layer for the printing.

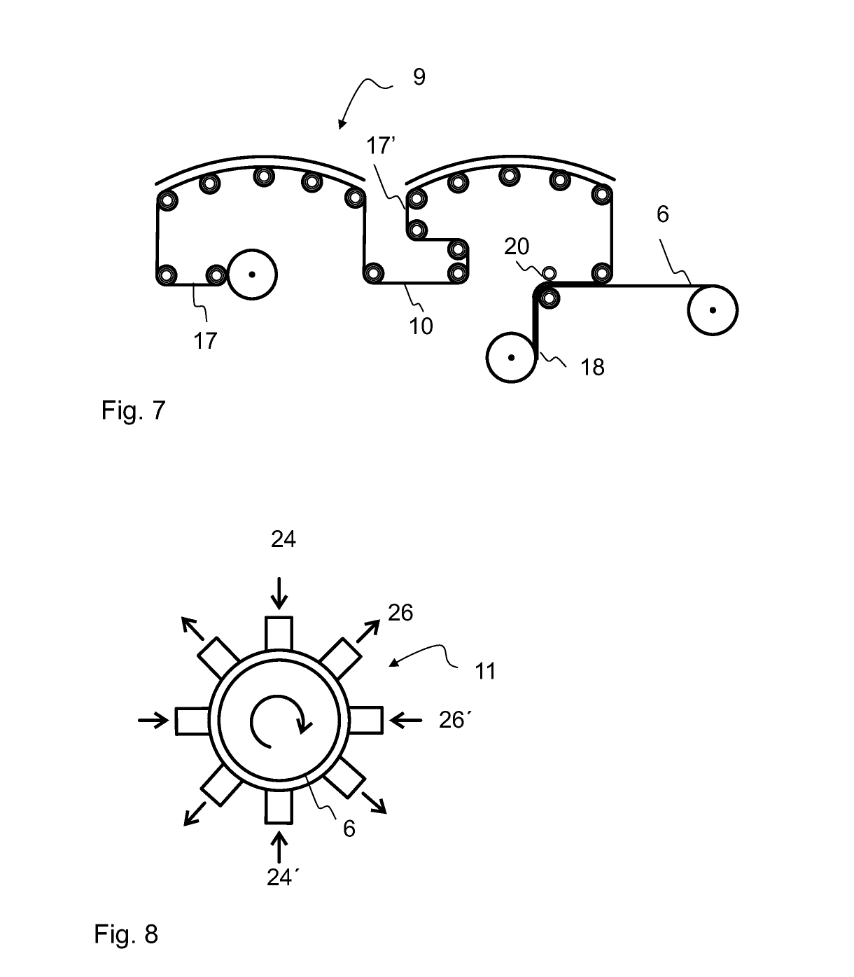

Referring to FIG. 7, the facestock layer 6 of the label may be coated with an inorganic layer during label laminating process 9. The laminating process may include steps of unwinding of the backing material; siliconizing 17 the backing material so as to form a release liner 10; coating the siliconized liner with a layer of adhesive 16 in an adhesive station 17′ and laminating the adhesive coated release liner with the face material 6 so as to form an adhesive label laminate 18 from which the individual labels may be cut out. Optionally, it is possible that the adhesive is already coated to the release liner comprising silicone, i.e. the laminating process does not include the siliconizing and adhesive station for the coating of adhesive. Instead, the laminating process may include unwinding the release liner coated with an adhesive layer and activating the adhesive layer of the release liner prior to laminating step. The facestock layer 6 of the label may be coated with an inorganic layer 14 during the label laminating process, for example before the laminating nip 20 or after the laminating. If the coating is performed before the laminating nip, the coating layer may be produced on the second side of the facestock layer further contacting the adhesive layer. It is also possible that the facestock layer 6 already includes the inorganic coating layer, i.e. the facestock is not coated during the lamination process. The graphical patterns may be printed to the facestock prior to laminating process. Alternatively, the facestock layer may be printed after the lamination. The individual labels may be cut out from the label laminate structure.

According to one embodiment, the label may be linerless, i.e. a facestock 6 of the label 3 comprises an activatable adhesive layer. Due to the acitvatable adhesive layer there is no need for a separate release liner. Thus, the laminating step may be avoided. The facestock of the linerless label may be coated with inorganic layer prior to coating with the adhesive. Preferably, the inorganic coating layer is provided on the second surface of the facestock and subsequently coated with an activatable adhesive layer so that the adhesive layer contacts a surface of the inorganic layer. Thanks to the activatable adhesive, which is non-tacky prior to activation, the facestock comprising adhesive may also be continuous and wound up to a roll.

According to an embodiment, an inorganic coating layer is created by using Atomic Layer Deposition (ALD) technology on at least one surface of the label or packaging material in order to prevent transfer of migrating substances from the part of the package into the product inside the package. The migrating substances include printing inks, primers, lacquers and overprint varnishes applied by a printing and/or coating process, such as flexography, gravure, letterpress, off-set, screen, non-impact printing or roller coating. Thanks to the barrier layer it is possible to use printing inks susceptible for migration, such as UV flexo inks, also in packages containing food or other products sensitive for foreign substances or contamination. Potential substances for migration include, for example, ink additives such as photo initiators used in UV inks, e.g. 4-methylbenzophenone and benzophenone, low molecular weight substances or substances consisting of small and mobile molecules.

The inorganic coating layer may also provide a good adhesion to the part of a package, such as a plastic film or paper that is coated. Thanks to the good adhesion, peeling or delamination of the coated structure may be avoided.

With atomic layer deposition of inorganic coating the barrier properties of the packages can be enhanced. ALD technology can be used both for plastic materials and papers, for example plasma assisted atomic layer deposition (PA-ALD) is suitable for low temperature applications, such as for plastic films. According to an embodiment the barrier layer prevents the migration. The overall migration of migrating substance(s) from the printed layer through the inorganic coating layer is less than 60 ppm (0.006%), for example not more than 10 ppm or 1 ppm, preferably not more than 50 ppb or not more than 10 ppb. The overall migration may be between 10 ppb to 60 ppm, or between 50 ppb to 60 ppm. Alternatively, it may be between 10 ppb and 10 ppm or between 50 ppb and 10 ppm, preferably between 10 ppb and 1 ppm or between 50 ppb and 1 ppm.

In an atomic layer deposition process a substrate material, such as plastic film, is deposited with a coating material in a controlled manner layer-by layer, i.e. one atomic layer at a time using sequential surface reactions. In the coating of binary compounds, such as metal oxides, a reaction cycle consists of two reaction steps having different precursors, for example, TMA (trimethyl aluminium) and O₃ for manufacturing a layer of Al₂O₃. The coating process may be of the batch type or continuous. Preferably the coating process is continuous, roll-to-roll process, wherein a continuous web of substrate material can be coated.

According to an embodiment, the substrate material may be coated by using a molecular layer deposition (MLD) technique in order to produce hybrid organic-inorganic coatings. MLD is also based on sequential surface reactions, in which molecular fragments are deposited on the surface by using e.g. organic and inorganic precursors. The hybrid organic-inorganic coating may be, for example, alucone, also known as poly(aluminium ethylene glycol). Alucone coating is provided e.g. by sequential exposures of trimethyl aluminium (TMA) and ethylene glycol (EG).

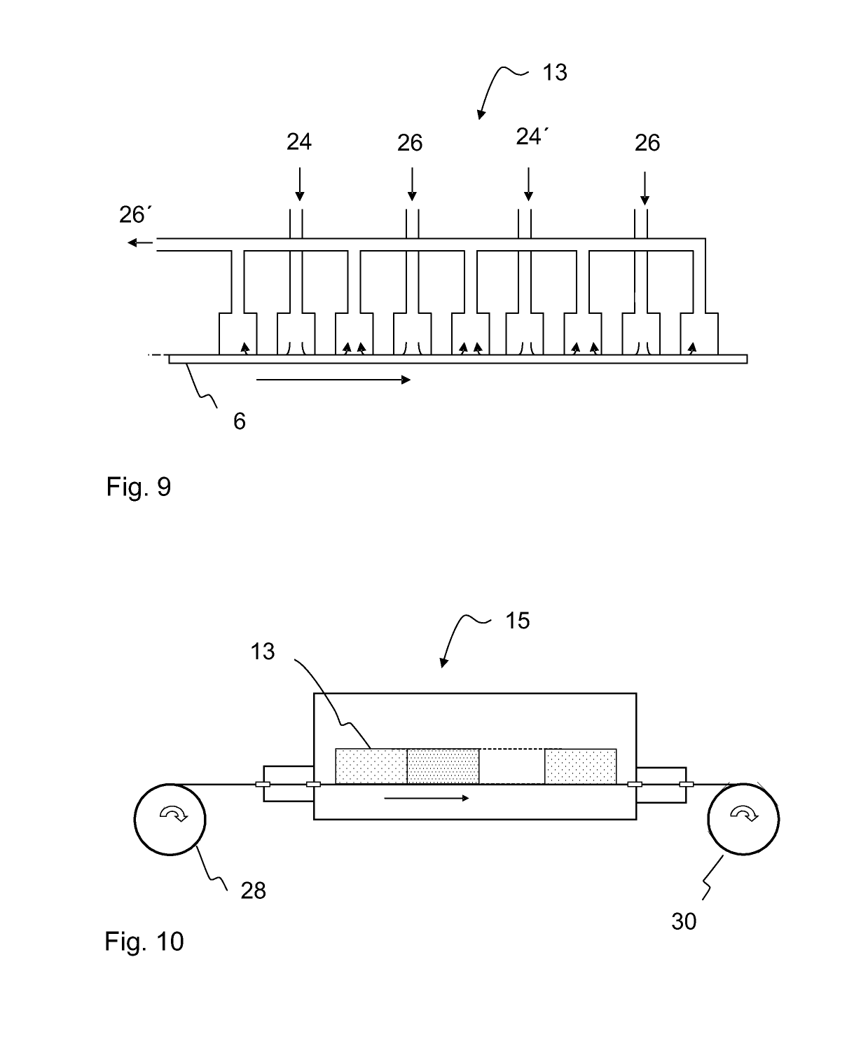

Referring to FIG. 8, a continuous ALD process may consists of a moving substrate system 11, in which the substrate material, such as a facestock of a label, is mounted on a rotating drum. In a rotating drum the surface of the substrate passes regions containing the precursor gases A 24 and B 24′ with purge 26′ and exhaust 26 regions between them to ensure that there is no intermixing of precursors. Each precursor exposure step saturates the surface with a monomolecular layer of that precursor. One rotation of the drum will produce one ALD cycle. Number of rotations of the drum may be adjusted in order to control the thickness of the coating layer. For example, at a rotation speed of 500 rpm rotation speed a coating having a thickness of about 40 nm can be obtained in 1 minute. However, in this rotating drum process the dimensions of the substrate are limited. Thus, a continuous roll-to-roll process is preferred, which enables the coating of long substrates having a length of for example 2000 m. For example, the roll-to-roll process may consist of a drum enabling the substrate web to make multiple passes through the deposition region e.g. by allowing the substrate web to take a helical path around the drum.

FIG. 9 shows a schematic presentation of an example embodiment of one module 13 in a continuous ALD process. The substrate web, such as a plastic facestock 6, will be on a continuous loop, and each pass will give one coating layer. Thicker coatings will be achieved using multiple passes of a substrate web.

In FIG. 10 a schematic presentation of an example embodiment of roll-to-roll ALD process 15 is presented. The process consists of a input substrate web roll 28, an ALD coating unit consisting of several coating modules 13 and an output roll 30 consisting of a substrate having an inorganic coating layer.

For example, to produce a coating layer of a compound AB, the substrate is exposed to the precursor of A, P_{A}. A monolayer of P_{A} is adsorbed on the surface and the excess material (precursor and reaction by-products) is purged away. The substrate is then exposed to the precursor of B, P_{B}. It reacts to form a layer AB, and any excess of P_{B} is purged away. Then the substrate is exposed to P_{A} again, and so on. In this way, the deposited coating is built up one layer at a time in a completely controllable manner. The thickness of the coating is proportional to the number of complete AB cycles.

As an example, one pulsing cycle of ALD process for manufacturing Al₂O₃ coating on the plastic web includes at least the following steps:

supplying a plastic web to the ALD coating unit;
pulsing metal precursor TMA (trimethyl aluminium) to the reaction space; reacting the TMA with the OH groups on the substrate surface;
purging the reaction chamber with inert gas (e.g. N₂) so as to release methane molecules from the surface;
pulsing non-metal precursor (counter reactant) H₂O to the reaction space so as to react with the TMA molecule fragments attached to the substrate surface;
purging the reaction chamber with inert gas (e.g. N₂) in order to remove H₂O molecules and methane molecules released from the surface reactions.
The water may be replaced in a low temperature ALD process with ozone or plasma generated oxygen radicals in order to improve process efficiency, e.g. to enable shorter process times.

The metal precursor and counter reactant for other inorganic coatings may be, for example, for SiO₂ coating TPS (tris(tert-pentoxy)silanol) and TMA, for TiO₂ coating TTIP (titanium tetraisopropoxide) and H₂O or TiCl₄ and H₂O, TDMAT (tetrakis(dimethylamido)titanium) and O₂ plasma or O₃. Deposition temperatures may be, for example, between 30 and 180° C. For plastic films, temperatures below the melting temperature of the polymer are preferably used.

The coating layer thickness can be controlled by repeating the pulsing cycle comprising pulsing source vapors into a reactor alternately, one at a time, separated by purging or evacuation periods. In a continuous roll-to-roll process the number of coating modules may be adjusted in order to control the coating thickness. For example, in rotating drum a coating thickness of Al₂O₃ from 40 to 170 nm can be provided. Also thinner coatings may be provided, e.g. coatings having a thickness of between 25 and 30 nm or between 10 and 15 nm.

Thanks to the atomic layer deposition, a uniform inorganic coating layer with a controlled thickness can be obtained, regardless of e.g. the shape of the substrate. The coating layer may also be pinhole-free.

The thickness of the inorganic coating layer is smaller than 500 nm, preferably smaller than 150 nm or smaller than 100 nm. The thickness may be most preferably smaller than 25 nm. For example, the thickness of the coating is at least 0.1 nm, at least 10 nm, or at least 50 nm. The thickness of the inorganic coating layer may affect the transparency and/or the opacity the plastic film. Thus, a thin coating layer is preferred in order to provide a film having a opacity lower than 10, preferably lower than 5, and most preferably lower than 4. However, the coating should be thick enough to provide an effective barrier layer against the migration of printing inks of the printing layer through the coating. The thickness of the inorganic coating layer effective for reducing the amount migration of printing ink substance(s) from the printing layer may be, for example, between 0.1 nm and 500 nm or between 10 and 250 nm, preferably between 50 and 200 nm or between 80 and 150 nm.

According to an example, the thickness of TiO₂ or Al₂O₃ coating layer may be between 70 and 130 nm, preferably between 80 and 120 nm, in order to prevent or at least to reduce the content of substances migrating through the layer. The inorganic barrier layer may block at least 70% or at least 80% or at least 90%, preferably at least 95% or at least 98% of substance(s) susceptible for migration, e.g. flexographic printing ink, through the plastic film.

According to some embodiments, a plastic film of a package or a face stock of a label is based on polyolefin polymer(s). Preferably a label contains a face stock consisting of polyolefin film(s). The face stock may comprise at least one of the following: polypropylene (PP) film and polyethylene (PE) film. Polyolefin based face stock may have effect on environmental aspects of the labels. Polyolefin based face stock may effect on enabling environmental friendly labeling. Polyolefin based face stock may effect on enabling re-cycling of labeled plastic packages.

The face stock of label or the plastic film of package used in any of the embodiments may comprise polypropylene at least 55 wt. %, or preferably at least 75 wt. %, or more preferably at least 85 wt. % of the total weight of polymer based materials. An amount of polypropylene may be less than 98 wt. % or less than 95 wt. %. Total content of polypropylene based polymers may be between 55 and 98 wt. % or between 55 and 95 wt. %. Polypropylene based face stock has effect on clarity/transparency of the label. Polypropylene based face stock may provide high transparency and “no-label look” for the label allowing the objects beneath to be seen through the face stock. Polypropylene may provide effect on haze of the faces stock. Haze of the face stock comprising 55 to 98 wt. % of polypropylene is less than 25, preferably less than 10%, more preferably less than 5%, or less than 2%. Haze of the polypropylene based face stock may be for example between 0.5 and 10%, or between 1 and 5%, when measured according to standard ASTM D1003. Polypropylene may also have effect on dimensional stability of the film. Further it may have effect on stiffness of the film. Increased stiffness of the film allows thinner films to be used. Polypropylene face stock may be used in rigid bottle applications requiring excellent transparency and the ‘no-label look’, e.g. in beverage labeling.

Alternatively, the face stock of label or the plastic film of package used in any of the embodiments may comprise polyethylene based polymers at least 55 wt. %, or preferably at least 75 wt. %, or more preferably at least 85 wt. % of the total weight of polymer based materials. Total content of polyethylene based polymers may be between 55 and 98 wt. % or between 55 and 95 wt. %. Polyethylene may provide effect of conformability. Polyethylene based face stock may allow labeling products having complex shapes and squeezable packages. Polyethylene may also have effect on printing properties. For example, polyethylene based face stock may conform well to package contours and flex well with squeezable packaging. Polyethylene based films may be used in personal care and home care labeling.

According to at least some embodiments, the plastic film or face stock comprising or consisting of polypropylene is oriented at least in one direction. Film may be monoaxially oriented in machine direction (MD), i.e. in running direction of the continuous plastic film (web). Alternatively, the film may be monoaxially oriented in cross direction (CD), i.e. in the direction perpendicular to the machine direction. Alternatively, the film may be oriented both in MD and in CD, i.e. the film may have biaxial orientation. Monoaxial orientation, also referred to as uniaxial orientation, refers to the orientation of polymer chains of the film in one direction. Orientation under uniaxial stress provides orientation of the polymer chains of the plastic film in the direction of stress provided. In other words, the polymer chains may be oriented at least partially in the direction of stretching (drawing). Machine direction stretching is normally done by means of a machine direction orienter via rolls with gradually increasing speed. The rolls are heated sufficiently to bring the film to a suitable temperature, which is normally below the melting temperature (Tₘ), or around the glass transition temperature (T_{g}) of the polymer. Biaxial orientation may be done through a tenter frame process which creates different degrees of orientation in the MD and CD directions. The films may also be oriented by using so called double bubble tubular stretching process which produces similar degrees of orientation in both the MD and TD directions. Orientation may effect on stiffness of the film. Increased stiffness of the film may allow e.g. thinner face stock to be used thus providing more cost-efficient labeling. Orientation may also provide an effect of barrier capability of the film.

According to at least some embodiments, the oriented film is further heat-set so as to provide non-shrink film having limited heat shrinking capability. Shrinkage of non-shrink film may be less than 10%, or preferably less than 5% at temperatures between 25 and 150° C. For example, a label comprising pressure sensitive adhesive may further comprise oriented and heat-set face stock. The oriented and heat-set face stock preferably consists of oriented heat-set film(s). Alternatively, the oriented film may be shrinkable in the orientation direction of the film under exposure to external energy. Films having shrinkability are not heat-set after orientation. Film may shrink at least 15%, preferably at least 25% or more preferably at least 35% between temperature of 65 and 120° C.

According to an example, the plastic film or face stock comprising or consisting of polyethylene may be non-oriented. The non-oriented films may be manufactured by blown film extrusion technology. Alternatively, the non-oriented films may be produced by cast extrusion technology.

According to at least some embodiments, the inorganic coating layer is composed of at least one of the following metal oxide(s), silicon oxide(s) and silicon nitride(s). Preferably, the inorganic coating layer contains at least one of the following metal oxide(s) and silicon oxide(s). More preferably, the inorganic coating layer contains metal oxide(s). Metal oxide may be at least one of the following TiO₂ and Al₂O₃. According to an embodiment, the inorganic coating layer consists of TiO₂. According to an embodiment, the inorganic coating layer consists of Al₂O₃.

According to at least some embodiments, the inorganic coating layer of a film comprising or consisting of polyolefin(s) includes at least one of the following: TiO₂, Al₂O₃, SiO₂, Si₃N₄, AlSiOₓ, and ZnO. Preferably, the inorganic coating layer consists of at least one of the following metal oxide(s) and silicon oxide(s). More preferably, the inorganic coating layer consists of at least one of the following TiO₂ and Al₂O₃.

According to an example, a non-shrinkable face stock of label is oriented at least in one direction and includes polypropylene based polymers between 55 and 98 wt. % or between 55 and 95 wt. %. The face stock film is further coated with inorganic coating layer comprising at least one of the following TiO₂ and Al₂O₃. For example, the inorganic coating consists both TiO₂ and Al₂O₃, preferably the coating consists of TiO₂ or Al₂O₃. The label structure further comprises an adhesive layer against the second surface of the face stock layer. The inorganic coating layer is preferably at least between the face stock layer and the adhesive layer.

According to another example, a face stock of label is non-oriented and includes polyethylene based polymers between 55 and 98 wt. % or between 55 and 95 wt. %. The face stock is further coated with inorganic coating layer comprising at least one of the following TiO₂ and Al₂O₃. For example, the inorganic coating consists both TiO₂ and Al₂O₃, preferably the coating consists of TiO₂ or Al₂O₃. The label structure further comprises an adhesive layer against the second surface of the face stock layer. The inorganic coating layer is preferably at least between the face stock layer and the adhesive layer.

The embodiments described above are only example embodiments of the invention and a person skilled in the art will readily recognize that they may be combined in various ways to generate further embodiments without deviating from the basic underlying invention.

1. A label comprising:
a plastic facestock having a first surface and a second surface;
at least one inorganic coating layer, and
a printing layer, wherein the inorganic coating layer composing of at least one of the following metal oxide(s) and silicon nitride(s) is provided by continuous atomic layer deposition onto the second surface of the plastic facestock, and wherein the inorganic coating layer is configured to provide a barrier layer for migration of at least one substance from the printing layer.

2. The label according to claim 1, wherein thickness of the inorganic coating layer is smaller than 500 nm, preferably smaller than 150 nm or smaller than 100 nm.

3. (canceled)

4. The label according to claim 1, wherein the inorganic coating layer comprises at least one of the following: TiO₂, Al₂O₃, SiO₂, Si₃N₄, AlSiOₓ, and ZnO.

5. The label according to claim 1, wherein the inorganic coating layer consists of at least one of the following metal oxide(s) and silicon oxide(s).

6. The label according to claim 1, wherein the inorganic coating layer consists of at least one of the following TiO₂ and Al₂O₃.

7. The label according to claim 1, wherein the opacity of the facestock is lower than 10%, preferably lower than 5%, or lower than 4% measured according to the standard ISO 2471.

8. The label according to claim 1, wherein the printing layer comprises at least one migrating substance from the group consisting of printing inks, primers, lacquers and overprint varnishes.

9. The label according to claim 1, wherein the printing layer comprises migrating substance consisting of UV-curable printing ink comprising at least one of the following photoinitiator: benzophenol, acetophenol, tertiary amin, acrylic amin, and 2-isopropylthioxanthone.

10. The label according to claim 1 wherein the migration of the at least one substance of the printing layer is less than 60 ppm, preferably equal or less than 10 ppm.

11. The label according to claim 1, wherein the label comprises an adhesive layer against the second surface of the facestock layer and the inorganic coating layer between the facestock layer and the adhesive layer.

12. The label according to claim 11, wherein the adhesive layer consists of a pressure sensitive adhesive.

13. A method for producing a label including a plastic facestock having a first surface and a second surface, at least one inorganic coating layer, and a printing layer, the method comprising:
providing the plastic facestock;
coating the second surface of the plastic facestock by continuous atomic layer deposition providing the inorganic coating layer composing of at least one of the following metal oxide(s), silicon oxide(s) and silicon nitride(s);
printing the facestock so as to form a printed facestock; and
cutting the printed facestock so as to form a printed label.

14. The method according to claim 13, wherein method further comprises coating the facestock with an adhesive layer.

15. The method according to claim 14, wherein the coating of the facestock with inorganic material is performed prior to coating the facestock with the adhesive layer.

16. A facestock for labels, wherein the facestock comprises a first surface, a second surface, at least one inorganic coating layer, and a printing layer, wherein the inorganic coating layer composing of at least one of the following metal oxide(s), silicon oxide(s) and silicon nitride(s) is provided by continuous atomic layer deposition onto the second surface of the facestock, and wherein the inorganic layer is configured to provide a barrier layer for migration of at least one substance from the printing layer.

17. The facestock according to claim 16, wherein thickness of the inorganic coating layer is smaller than 500 nm, preferably smaller than 150 nm, or smaller than 100 nm.

18. (canceled)

19. The facestock according to claim 16, wherein the inorganic coating layer comprises at least one of the following: TiO₂, Al₂O₃, SiO₂, Si₃N₄, AlSiOₓ, and ZnO.

20. The facestock according to claim 16, wherein the inorganic coating layer consists of at least one of the following metal oxide(s) and silicon oxide(s).

21. The facestock according to claim 16, wherein the inorganic coating layer consists of at least one of the following TiO₂ and Al₂O₃.

22. The facestock according to claim 16, wherein the opacity of the facestock is lower than 10%, preferably lower than 5%, or lower than 4% measured according to the standard ISO 2471.

23. The facestock according to claim 16, wherein the printing layer comprises at least one migrating substance from the group consisting of printing inks, primers, lacquers and overprint varnishes.

24. The facestock according to claim 16, wherein the printing layer comprises migrating substance consisting of UV-curable printing ink comprising at least one of the following photoinitiator: benzophenol, acetophenol, tertiary amin, acrylic amin, and 2-isopropylthioxanthone.

25. The facestock according to claim 16, wherein the migration of the at least one substance of the printing layer is less than 60 ppm, preferably equal or less than 10 ppm.

26. A use of a label according to claim 1 for labelling of an item.

27. A combination of an item and a label attached to the item, the label comprising a plastic facestock having a first surface and a second surface, at least one inorganic coating layer, and a printing layer, wherein the inorganic coating layer composing of at least one of the following metal oxide(s), silicon oxide(s) and silicon (nitride(s) is provided by continuous atomic layer deposition onto the second surface of the plastic facestock, and wherein the inorganic coating layer, and wherein the inorganic coating layer is configured to provide a barrier layer for migration of at least one substance from the printing layer.
